(19) United States
(12) Patent Application Publication
(10) Pub. No.: US 2009/0290900 A1
(43) Pub. Date: Nov. 26, 2009

(54) Developing Device, Image Forming Apparatus, and Method of Manufacturing Developing Device

(75) Inventors: Masahiro MAEDA, Matsumoto-shi (JP); Tomohiro ARUGA, Matsumoto-shi (JP); Yoichi YAMADA, Shiojiri-shi (JP); Takatomo FUKUMOTO, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/429,084

(22) Filed: Apr. 23, 2009

(30) Foreign Application Priority Data
May 23, 2008 (JP) 2008-135034

(51) Int. Cl. G03G 15/08

(52) U.S. Cl. 399/103; 399/279; 399/286

(57) ABSTRACT

A developing device includes: a housing that stores toner therein; a toner carrying roller that is attached to the housing by a shaft and is rotated in a predetermined rotation direction while carrying charged toner on a surface of the toner carrying roller to transport the toner to the outside of the housing; and a seal member that extends in a direction of a rotation axis of the toner carrying roller and has one end fixed to the housing and the other end in contact with the surface of the toner carrying roller to prevent the toner from leaking out of the housing, wherein a plurality of convex portions having top surfaces constituting a part of the same cylindrical surface are formed on the surface of the toner carrying roller, and at least a part of the seal member in contact with the surface of the toner carrying roller is made of a material having a contact angle of 105° or more with respect to water.

### CROSS-REFERENCE TO RELATED APPLICATION

The entire disclosure of Japanese Patent Application No. 2008-135034, filed May 23, 2008 is expressly incorporated by reference herein.

### BACKGROUND

1. Technical Field

The present invention relates to a developing device having a toner carrying roller that carries toner on a surface thereof, a method of manufacturing the same, and an image forming apparatus that develops an electrostatic latent image by the toner using the toner carrying roller.

2. Related Art

A developing device for developing an electrostatic latent image carried on an image carrier by toner, and an image forming apparatus having the developing device-have been widely used, in which a toner carrying roller having a substantially cylindrical shape and carrying toner on a surface thereof is disposed opposite to the image carrier. To improve characteristics of the toner carried on the surface of such a toner carrying roller, the present applicant disclosed a developing device employing a toner carrying roller provided with convex portions regularly disposed on a surface of a roller formed in a cylindrical shape and concave portions surrounding the convex portions. Such a structure has an advantage that it is easy to control a charging amount or a thickness of a toner layer carried on the surface of the roller since the unevenness pattern formed on the surface is regular.

In the image forming apparatus configured as described above, a seal member is provided in a gap between a developing roller as the toner carrying roller and a developer housing, and the seal member is in contact with the surface of the developing roller, thereby preventing the toner from leaking.

JP-A-2007-121947 is an example of related art.

In the related art, the seal member is in contact with the surface of developing roller along a rotation direction of the developing roller, that is, in a trail direction, thereby preventing the toner on the surface of the developing roller from being scratched. However, since the seal member is in press contact with the developing roller having the toner attached to the surface thereof, it is inevitable that the toner or additives separated from the toner is fixed to surface of the seal member. When the toner or the like is fixed to the seal member as described above, the toner may leak due to seal defect and the fixing of the toner may result in filming caused by the toner fixed to the surface of the developing roller.

Particularly, when the regular unevenness pattern is formed on the surface of the toner carrying roller as described in the related art, the toner is also regularly fixed to the seal member. Accordingly, it is conceivable that toner leakage or filming easily occurs by partially fixing the toner or the like.

### SUMMARY

An advantage of some aspects of the invention is that it provides a developing device provided with a toner carrying roller having a plurality of concave portions on a surface thereof, an image forming apparatus, and a method of manufacturing the developing apparatus, which are capable of preventing problems such as filming and leakage of toner caused by fixing the toner or the like to the seal member.

According to an aspect of the invention, a developing device includes: a housing that stores toner therein; a toner carrying roller that is attached to the housing by a shaft and is rotated in a predetermined rotation direction while carrying charged toner on a surface of the toner carrying roller to transport the toner to the outside of the housing; and a seal member that extends in a direction of a rotation axis of the toner carrying roller and has one end fixed to the housing and the other end in contact with the surface of the toner carrying roller to prevent the toner from leaking out of the housing.

In the developing device according to this aspect of the invention, a plurality of convex portions having top surfaces constituting a part of the same cylindrical surface are formed on the surface of the toner carrying roller, and at least a part of the seal member in contact with the surface of the toner carrying roller is made of a material having a contact angle of 105° or more with respect to water. With such a configuration, the part of the seal member in contact with the surface of the toner carrying roller has the large contact angle with respect to water and is formed of a high deformation property material, and thus the fixing of toner or the like to the seal member caused by the contact with the surface of the toner carrying roller hardly occurs. For this reason, it is possible to effectively suppress the problem such as filming and toner leakage caused by the fixing of the toner or the like to the seal member.

In the developing device according to this aspect of the invention, a plurality of convex portions having top surfaces constituting a part of the same cylindrical surface are formed on the surface of the toner carrying roller, and at least a part of the seal member in contact with the surface of the toner carrying roller is made of polytetrafluoroethylene (PTFE) resin or ethylene-tetrafluoroethylene copolymer (ETFE) resin. Such a material has a high deformation property and attachment such as toner or the like hardly occurs. For this reason, it is possible to effectively suppress the problem such as filming and toner leakage caused by the fixing of the toner or the like to the seal member.

Particularly, in recent, a low melting point of toner is required to reduce power consumption of an image forming apparatus by decreasing a fixing temperature, and thus the problem such as filming and fixing of toner or the like has been disclosed. However, the developing device according to the invention can cope with such a problem.

In this case, it is preferable that when the convex portions formed on the surface of the toner carrying roller are formed by a through-feed rolling process, the predetermined rotation direction is the same direction as the rotation direction of the toner carrying roller at the time of the through-feed rolling process.

In the through-feed rolling process, in a state where dies are pressed on a rod-shaped or cylindrical process target material, the process target material is moved in an axial direction thereof while rotating the process target material about an axial center, thereby forming the surface of the process target material in a predetermined shape. In this case, a support (guide) as backup means is provided at a position opposite to the dies with the process target material therebetween and the support is in contact with the process target material, thereby preventing displacement or distortion of the process target material. According to such a processing method, the surface of the process target material is rubbed on the support while the process target material is rotated. At that time, the top surfaces of the convex portions formed on the surface of the process target material are pushed up toward the upstream side of the rotation direction, and thus plastic deformation is inevitable.

By such plastic deformation, inclination of the side surface at a part (hereinafter, referred to as “edge portion”) transferring from the top surface of each convex portion to the side surface is rapidly changed on the rotation direction upstream side at the processing time and is gently changed on the down stream side. In more extreme case, the edge portion protrudes sharply in a burr shape on the rotation direction upstream side at the processing time. When a toner carrying roller processed as described above is mounted on the developing device, such a protruding portion wears out the surface of the seal member in contact with the surface of the seal member when the toner carrying roller is rotated, thereby reducing durability of the developing device. When the rotation direction of the toner carrying roller mounted on the developing device is the same direction as the rotation direction at the through-feed rolling process, the burr-shaped protruding portion is toward the rear side. Accordingly, the wearing of the seal member due to the contact between the seal member and the convex portion is suppressed, thereby improving durability of the developing device.

In addition, it is preferable that on the surface of the toner carrying roller, a difference in height between the convex portions and the concave portions surrounding the convex portions is larger than a volume average diameter of the toner. When the difference in height between the convex portions and the concave portions surrounding the convex portions is small, the upper part of toner carried in the concave portions may come into contact with the seal member, thereby causing the rubbing with the seal member. Accordingly, attachment to the seal member may occur. In addition, the toner may be fixed in the concave portions by pressing the toner to the concave portions. When the difference in height between the convex portions and the concave portion is larger than the volume average diameter of the toner, a possibility of the contact between seal member and the toner carried in the concave portions and the fixing of toner or the like hardly occurs.

According to another aspect of the invention, an image forming apparatus includes: a housing that stores toner therein; a toner carrying roller that is attached to the housing by a shaft and is rotated in a predetermined rotation direction while carrying charged toner on a surface of the toner carrying roller to transport the toner to the outside of the housing; a seal member that extends in a direction of a rotation axis of the toner carrying roller and has one end fixed to the housing and the other end in contact with the surface of the toner carrying roller to prevent the toner from leaking out of the housing; and an image carrier that is disposed opposite to the toner carrying roller and carries an electrostatic latent image on a surface thereof, wherein a plurality of convex portions having top surfaces constituting a part of the same cylindrical surface are formed on the surface of the toner carrying roller, and at least a part of the seal member in contact with the surface of the toner carrying roller is made of a material having a contact angle of 105° or more with respect to water.

With such a configuration, similarly with the developing device, the fixing of toner or the like to the seal member caused by the contact with the surface of the toner carrying roller hardly occurs, and, it is possible to effectively suppress the problem such as filming and toner leakage caused by the fixing of the toner or the like to the seal member.

According to still another aspect of the invention, a method of manufacturing a developing device includes: forming regular unevenness on a surface of a substantially cylindrical roller material by a through-feed rolling process, thereby manufacturing a toner carrying roller; and providing a housing for storing toner therein with a seal member made of a material having a contact angle of 105° or more with respect to water, and attaching the toner carrying roller to be rotatable in a predetermined rotation direction by a shaft, wherein the predetermined rotation direction is the same direction as the rotation direction of the roller material at the time of the through-feed rolling process.

With such a configuration, the high deformation property is employed to the seal member and the rotation direction of the toner carrying roller mounted on the developing device is the same direction as the rotation direction at the processing time. Accordingly, similarly with the developing device, it is possible to effectively suppress the problem such as filming and toner leakage caused by the fixing of the toner or the like to the seal member.

For example, it is preferable that in the forming of the regular unevenness, the roller material is rotated in the same direction as the predetermined rotation direction in a state where dies and a support are in contact with a surface of the roller material at positions different from one another. In such a manufacturing method, since the roller material is rotated while the roller material is in contact with the support, plastic deformation of the convex portions occurs toward the rotation direction upstream side of the toner carrying roller in a real operation state, thereby preventing the seal member from being worn out.

### BRIEF DESCRIPTION OF THE DRAWINGS

The invention will be described with reference to the accompanying drawings, wherein like numbers reference like elements.

FIG. 1 is a diagram illustrating an image forming apparatus according to an embodiment of the invention.

FIG. 2 is a block diagram illustrating an electrical configuration of the image forming apparatus shown in FIG. 1.

FIG. 3 is a diagram illustrating appearance of a developer.

FIG. 4A is a diagram illustrating a structure of the developer.

FIG. 4B is a diagram illustrating a development bias waveform.

FIG. 5 is a diagram illustrating a developing roller and an enlarged part of a surface thereof.

FIGS. 6A and 6B are diagrams illustrating an outline of a method for manufacturing a developing roller according to the invention.

FIGS. 7A, 7B and 7C are diagrams illustrating sectional shapes of unevenness formed by a through-feed rolling process.

FIGS. 8A, 8B and 8C are diagrams illustrating shapes of edge portions of developing rollers.

FIG. 9 is a diagram illustrating a filming test result about seal members made of various kinds of materials.

### DESCRIPTION OF EXEMPLARY EMBODIMENTS

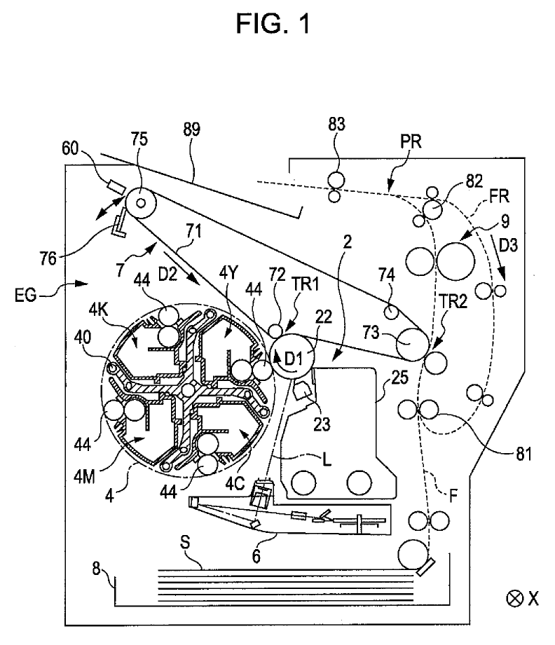

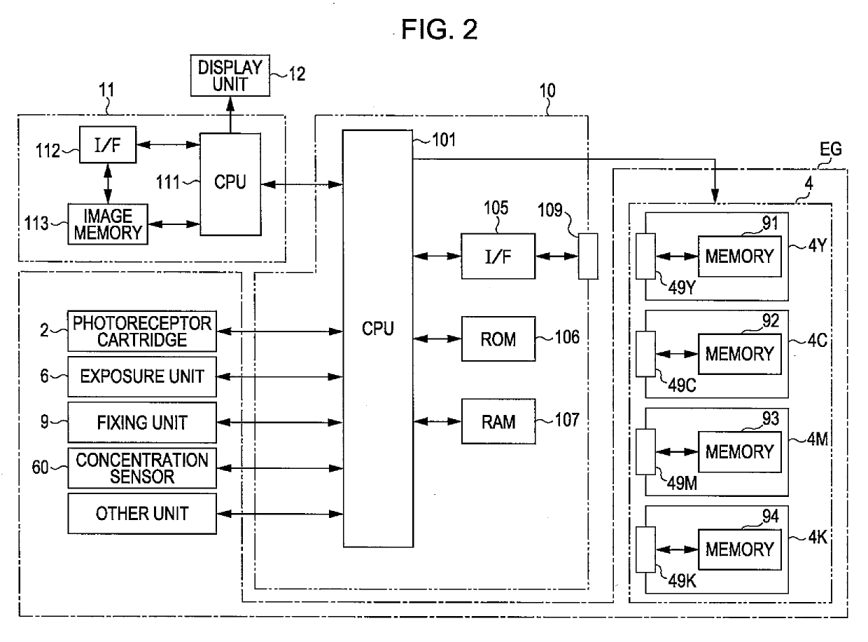

FIG. 1 is a diagram illustrating an image forming apparatus according to an embodiment of the invention. FIG. 2 is a block diagram illustrating an electrical configuration of the image forming apparatus shown in FIG. 1. This apparatus forms a full-color image by overlapping toner (developer) with 4 colors of yellow (Y), cyan (C), magenta (M), and black (K), or forms a monochromatic image using only black (K) toner. In the image forming apparatus, an image signal is transmitted from an external apparatus such as a host computer to a main controller 11, a CPU 101 provided in an engine controller 10 controls each unit of an engine unit EG in response to an instruction from the main controller 11 to perform a predetermined image forming operation, and forms an image corresponding to the image signal on a sheet S.

The engine unit EG is provided with a photoreceptor 22 rotatable in a direction indicated by an arrow D1 shown in FIG. 1. A charging unit 23, a rotary developing unit 4, and a cleaning portion 25 are disposed around the photoreceptor 22 along the rotation direction D1. A predetermined charging bias is applied to the charging unit 23, and the charging unit 23 uniformly charges an outer peripheral surface of the photoreceptor 22 to a predetermined surface potential. The cleaning portion 25 removes remaining toner attached to the surface of the photoreceptor 22 after a first transfer, and recovers the toner in a wasted toner tank provided therein. The photoreceptor 22, the charging unit 23, and the cleaning portion 25 integrally constitutes a photoreceptor cartridge 2, and the photoreceptor cartridge 2 is integrally attachable to and detachable from an apparatus body.

A light beam L is irradiated from an exposure unit 6 to the outer peripheral surface of the photoreceptor 22 charged by the charging unit 23. The exposure unit 6 irradiates the light beam L onto the photoreceptor 22 in response to an image signal transmitted from the external apparatus, thereby forming an electrostatic latent image corresponding to the image signal.

The electrostatic latent image formed as described above is developed with toner by the developing unit 4. That is, in the present embodiment, the developing unit 4 is provided with a support frame 40 rotatable about a rotation axis perpendicular to the surface of FIG. 1, a yellow developer 4Y, a cyan developer 4C, a magenta developer 4M, and a black developer 4K, which contain each color toner, as cartridges attachable to and detachable from the support frame 40. The developing unit 4 is controlled by the engine controller 10. The developing unit 4 is rotated on the basis of a control instruction from the engine controller 10. When the developers 4Y, 4C, 4M, and 4K are selectively positioned at a predetermined development position opposite to the photoreceptor 22 with a predetermined gap, a developing roller 44 provided at the corresponding developer and carries the selected color toner is disposed opposite to the photoreceptor 22 and the toner is applied from the developing roller 44 to the surface of the photoreceptor 22 at the opposite position. Accordingly, the electrostatic latent image formed on the photoreceptor 22 is developed with the selected toner color.

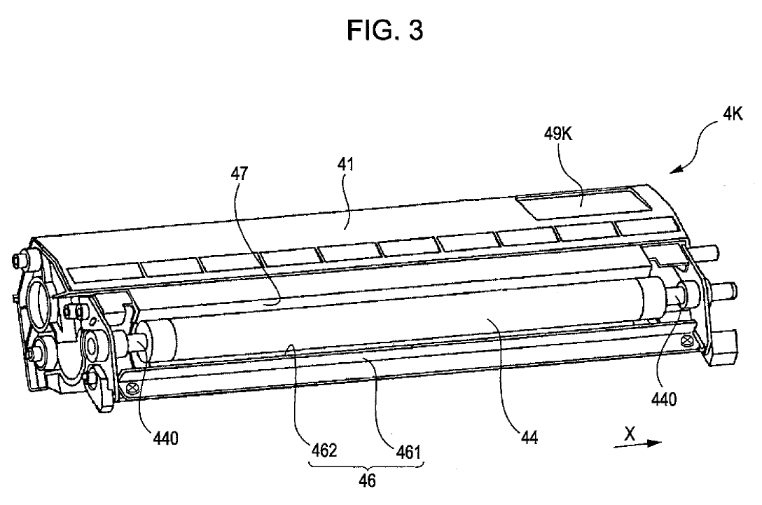

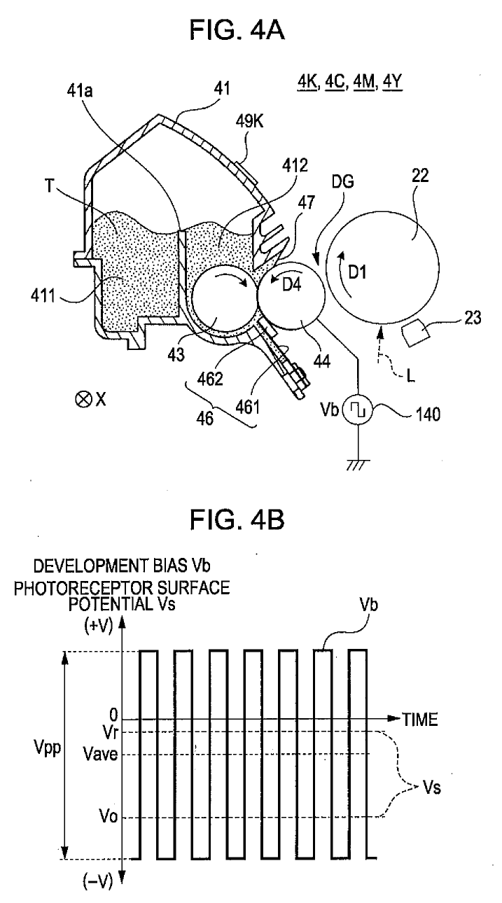

FIG. 3 is a diagram illustrating appearance of the developer. FIG. 4A is a cross-sectional view illustrating a structure of the developer. FIG. 4B is a diagram illustrating a relationship between a development bias waveform and a photoreceptor surface potential. All the developers 4Y, 4C, 4M, and 4K have the same structure. Accordingly, a configuration of the developer 4K will be described in more detail with reference to FIG. 3 and FIG. 4A. Structures and functions of the developers 4Y, 4C, and 4M are the same as those of the developer 4K.

In the developer 4K, a feeding roller 43 and a developing roller 44 are rotatably provided by shafts in a housing 41 for containing nonmagnetic toner T. When the developer 4K is positioned at the development positions the developing roller 44 is positioned at a position opposite to the photoreceptor 2 with a development gap DG, and the rollers 43 and 44 are engaged with a rotation driving portion (not shown) provided on the main body side and are rotated in a predetermined direction. The feeding roller 43 is formed of, for example, an elastic material such as foam urethane rubber and silicon rubber in a cylindrical shape. The developing roller 44 is formed of metal or alloy such as copper, aluminum, and stainless in a cylindrical shape. The two rollers 43 and 44 are rotated in contact with each other and thus the surface of the developing roller 44 is coated with the toner, thereby forming a toner layer with a predetermined thickness on the surface of the developing roller 44. In the embodiment, negative-charged toner is used, but positive-charged toner may be used.

An inner space of the housing 41 is divided into a first chamber 411 and a second chamber 412 by a partition wall 41a. The feeding roller 43 and the developing roller 44 are provided in the second chamber 412. Toner stored in the second chamber 412 is fed to the surface of the developing roller 44 while the toner flows and mixes by rotation of the rollers 43 and 44. Toner stored in the first chamber 411 is isolated from the feeding roller 43 and the developing roller 44, and thus the rotation does not cause the toner to flow. When the developing unit 4 is rotated with the developer kept, the toner is mixed and stirred with the toner stored in the second chamber 412.

As described above, in the developer, the inside of the housing is divided into the two chambers, the peripheries of the feeding roller 43 and the developing roller 44 are surrounded with the side wall and the partition wall 41a, and the second chamber 412 having a relatively small capacity is provided. Accordingly, even when the amount of remaining toner is decreased, toner is efficiently fed to the vicinity of the developing roller 44. In addition, the toner is fed from the first chamber 411 to the second chamber 412 by the rotation of the developing unit 4 and the whole toner is stirred by the rotation of the developing unit 4. Accordingly, an augerless structure without a stirring member (auger) for stirring toner in the developer is realized.

The developer 4K is provided with a restriction blade 46 for restricting the thickness of the toner layer formed on the surface of the developing roller 44 to a predetermined thickness. The restriction blade 46 is formed of a plate member 461 having elasticity such as stainless and bronze and an elastic member 462 made of a resin member such as silicon rubber and urethane rubber provided at a front end of the plate member 461. A rear end of the plate member 461 is fixed to the housing 41. The elastic member 462 provided at the front end of the plate member 461 is disposed on the more upstream side than the rear end of the plate member 461, in a rotation direction D4 of the developing roller 44 indicated by an arrow shown FIG. 4. The elastic member 462 comes into elastic contact with the surface of the developing roller 44 to form a restriction nip, thereby finally restricting the toner layer formed on the surface of the developing roller 44 to a predetermined thickness.

The toner layer formed on the surface of the developing roller 44 is sequentially transported to a position opposite to the photoreceptor 2 having the electrostatic latent image formed on the surface thereof by the rotation of the developing roller 44. A development bias is applied from a bias power supply 140 controlled by the engine controller 10, to the developing roller 44. As shown in FIG. 4B, after a surface potential Vs of the photoreceptor 22 is uniformly charged by the charging unit 23, the potential is decreased to approximately a rest potential Vr at the exposed portion to which the light beam L is irradiated from the exposure unit 6, and the potential becomes a substantially uniform potential Vo at a non-exposed portion to which the light beam is not irradiated. A development bias Vb applied to the developing roller 44 is a rectangular waveform overlapped with a direct-current potential Vave, a peak-to-peak voltage is represented by Vpp. When the development bias Vb is applied as described above, the toner carried on the developing roller 44 flies in the development gap DG and is partially attached to each part of the surface of the photoreceptor 22 in response to the surface potential Vs, thereby developing the electrostatic latent image formed on the photoreceptor 22 into a toner image of the toner color.

For example, a rectangular waveform voltage having a peak-to-peak voltage Vpp of 1500 V and a frequency of 3 kHz may be used as the development bias voltage Vb. The direct-current component Vave thereof may be set to a value necessary for obtaining a predetermined image concentration since a potential difference from the rest potential Vr of the photoreceptor 22 becomes so-called contrast to have an influence on the image concentration.

The housing 41 is provided with a seal member 47 in press contact with the surface of the developing roller 44 on the more downstream side than the position opposite to the photoreceptor 22 in the rotation direction of the developing roller 44. The seal member 47 is formed of a resin material having flexibility, and is a band-shaped film extending along a direction X parallel to the rotation axis of the developing roller 44. One end of the seal member 47 in a short-hand direction (direction along the rotation direction of the developing roller 44) perpendicular to the length direction X is fixed to the housing 41, and the other end is in contact with the surface of the developing roller 44. The other end is in contact with the developing roller 44 toward the downstream side of the rotation direction D4 of the developing roller 44, that is, in a trail direction. The seal member 47 guides the toner remaining on the surface of the developing roller 44 passing through the position opposite to the photoreceptor 22 into the housing 41, and prevents the toner in the housing 41 from leaking out.

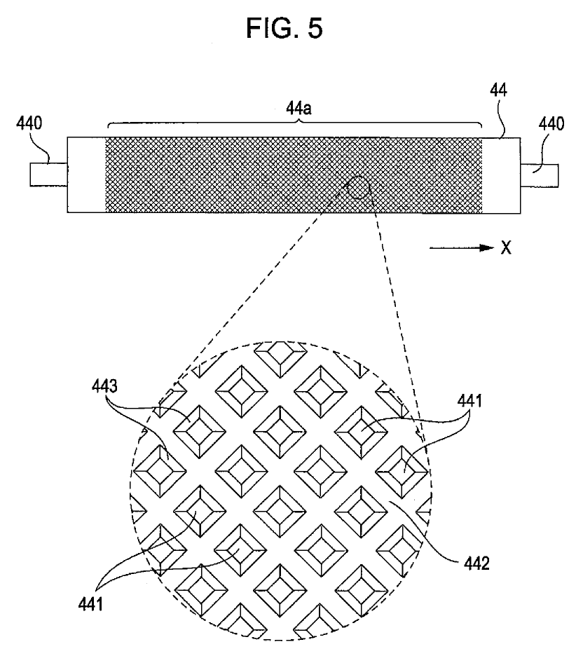

FIG. 5 is a diagram illustrating the developing roller 44 and an enlarged part of a surface thereof. The developing roller 44 has a substantially cylindrical roller shape, and a shaft 440 is provided at both ends of the length direction on the same axis as that of the developing roller 44. The shaft 440 is supported by the developer body, and thus the whole developing roller 44 is rotatable. A plurality of regularly arranged convex portions 441 and concave portions 442 surrounding the convex portions 441 are provided at a center portion 44a of the surface of the developing roller 44, as described in the partially enlarged diagram (in dotted-line circle) of FIG. 5.

Each of the convex portions 441 protrudes toward the front of FIG. 5, and a top surface of each convex portion 441 constitutes a part of a single cylindrical surface having the same axis as the rotation axis of the developing roller 44. The concave portions 442 are formed of continuous grooves surrounding the convex portions 441 in a net shape, and the whole concave portions 442 has the same axis as the rotation axis of the developing roller 44 forms one cylindrical surface different from the cylindrical surface formed by the convex portions 441. The convex portions 441 and the concave portions 442 are connected to each other by gentle side surfaces 443. That is, normal lines of the side surfaces 443 have a component toward the outside of a radius direction of the developing roller 44 (upward in FIG. 5), that is, in a direction away from the rotation axis of the developing roller 44.

The image forming apparatus is described with reference to FIG. 1 again. The toner image developed by the developing unit 4 as described above is transferred onto an intermediate transfer belt 71 of a transfer unit 7 in a first transfer region TR1. The transfer unit 7 is provided with the intermediate transfer belt 71 suspended to a plurality of rollers 72 to 75 and a driving portion (not shown) for rotating the intermediate transfer belt 71 in a predetermined rotation direction D2 by rotating the roller 73. In a case where a color image is transferred to a sheet S, toner images of colors formed on the photoreceptor 22 are overlapped with each other on the intermediate transfer belt 71 to form a color image, and the color image is transferred to the sheet S taken from a cassette 8 one by one and transported to a second transfer region TR2 along a transport path F.

In this case, to accurately transfer the image on the intermediate transfer belt 71 to a predetermined position on the sheet S, the time to transport the sheet S to the second transfer region TR2 is managed. Specifically, a gate roller 81 is provided on the just front side of the second transfer region TR2 on the transport path F, and the gate roller 81 is rotated according to the time of circulating the intermediate transfer belt 71, thereby transporting the sheet S to the second transfer region TR2 at a predetermined time.

The toner image is fixed on the sheet S, on which the color image is formed, by a fixing unit 9, and the sheet S is transported to a discharge tray 89 provided at an upper part of the apparatus body through a before-discharge roller 82 and a discharge roller 83. In case of forming images on both surface of the sheet S, the rotation direction of the discharge roller 83 is reversed at the time when the trailing end of the sheet S having an image formed on one surface thereof as described above is transported to a reverse portion PR of the rear of the before-discharge roller 82, thereby transporting the sheet S in a direction indicated by an arrow D3 along a reverse transport path FR. The sheet S is loaded on a transport path F again just before the gate roller 81. At this time, the surface of the sheet S on which the image is transferred and which is in contact with the intermediate transfer belt 72 in the second transfer region TR2 is a surface opposite to the surface on which the image is previously transferred. As described above, it is possible to form the images on both surface of the sheet S.

As shown in FIG. 2, each of the developers 4Y, 4C, 4M, and 4K is provided with memories 91 to 94 for storing data about a product lot and a use history of the developer, an amount of remaining toner, and the like. The developers 4Y, 4C, 4M, and 4K are provided with radio communicator 49Y, 49C, 49M, and 49K, respectively. As necessary, they selectively perform non-contact data communication with a radio communicator 109 provided on the main body side, and the data is transmitted and received between the CPU 101 and the memories 91 to 94 through an interface 105, thereby managing various kinds of data such as management of expendable supplies about the developer. In the embodiment, the non-contact data transmission and reception are performed using electromagnetic means such as radio communication. However, the main body and developers may be provided with connectors, and the data transmission and reception may be performed by mechanically connecting the connectors to each other.

As shown in FIG. 2, the apparatus is provided with a display unit 12 controlled by the CPU 111 of the main controller 11. The display unit 12 is formed of, for example, a liquid crystal display, and displays a predetermined message such as an operation guide, a progress of an image forming operation, an error of the apparatus, and time to exchange some units to a user, in response to a control instruction from the CPU 111.

In FIG. 2, Reference Numeral 113 denotes an image memory provided at the main controller 11 to store an image transmitted from an external apparatus such as a host computer through an interface 112. Reference Numeral 106 denotes a ROM for storing control data for controlling an operation program or the engine unit EG executed by the CPU 101, and Reference Numeral 107 denotes a RAM for temporarily storing an operation result or the other data in the CPU 101.

A cleaner 76 is provided in the vicinity of a roller 75. The cleaner 76 can be closed to and separated from the roller 75 by an electric clutch (not shown). In a state where the cleaner 76 is moved close to the roller 75, a blade of the cleaner 76 comes into contact with the surface of the intermediate transfer belt 71 suspended on the roller 75 and removes remaining toner attached to the outer peripheral surface of the intermediate transfer belt 71 after the second transfer.

A concentration sensor 60 is provided in the vicinity of the roller 75. The concentration sensor 60 is opposite to the surface of the intermediate transfer belt 71, and measures image concentration of the toner image formed on the outer peripheral surface of the intermediate belt 71 as necessary. In the apparatus, operation conditions of each unit having an influence on image quality are controlled, for example, a development bias applied to the developer, an intensity of the exposure light beam L, a tone correction characteristic of the apparatus, and the like.

The concentration sensor 60 is configured to output a signal corresponding to light and shade of a predetermined area on the intermediate transfer belt 71 by using, for example, a reflective photo sensor. The CPU 101 circumferentially circulates the intermediate transfer belt 71 and periodically performs sampling of a signal output from the concentration sensor 60, thereby detecting image concentration of each portion of the toner image on the intermediate transfer belt 71.

The restriction of the toner layer on the developing roller 44 in the developer 4K or the like of the image forming apparatus configured as described above will be described in detail. In the configuration of forming the unevenness on the surface of the developing roller 44 carrying the toner as described above, the toner can be carried on both of the convex portions 441 and the concave portions 442. However, in the embodiment, the restriction blade 46 comes into direct contact with the convex portions 441 on the surface of the developing roller 44, thereby removing the toner on the convex portion 441. The reason is as follows.

First, to form a uniform toner layer on the convex portions 441, it is necessary to precisely manage a gap between the restriction blade 46 and the convex portions 441. However, to carry the toner in only the concave portions 442, it is preferable to remove all the toner on the convex portions 441 by bringing the restrict blade 46 into contact with the concave portions 442, and thus it is relatively easy to realize the carrying of the toner. The amount of transported toner is determined by the capacity of the space between the restriction blade 46 and the concave portions 442, and thus it is possible to stabilize the amount of transported toner.

There is an advantage in a condition of the transported toner layer. That is, when the toner is carried on the convex portions 441, deterioration of the toner caused by the rubbing with the restriction blade 46 easily occurs. Specifically, fluidity or charging of the toner deteriorates, the toner becomes powder and coheres, or the toner is fixed to the developing roller 44 to cause filming. About this problem, when the toner is carried in the concave portions 442 which is not pressed so much from the restriction blade 46, such a problem can be solved. The toner carried on the convex portion 441 and the toner carried in the concave portions 442, manners of scraping with the restriction blade 46 are greatly different from each other. Accordingly, it is expected that there is a large difference in the charging amount of toner. However, such a difference is suppressed by carrying the toner in only the concave portions 442.

Particularly, in recent, to realize high precision of images or to reduce toner consumption and power consumption, a small particle size of toner or a low fixing temperature is required. However, the configuration in the embodiment can cope with such requirement. In the small particle size toner, since a saturation charging amount is high in spite of slow charging start, the charging amount of the toner carried on the convex portions 441 tends to become significantly higher (excessive charging) than that of the toner carried in the concave portions 442. Such a difference of the charging amount is represented on the image as a so-called development history. In toner with a low melting point, fixing of toner by rubbing, or fixing to the developing roller 44 easily occurs. However, in the configuration of carrying the toner in only the concave portions 442 according to the embodiment, such a problem hardly occurs.

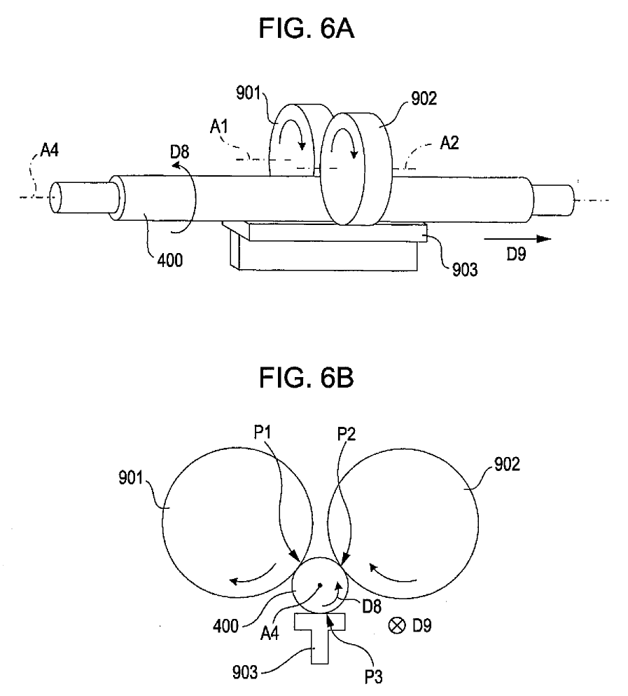

FIG. 6A and FIG. 6B are diagrams illustrating an outline of a method for manufacturing a developing roller according to the invention. The developing roller 44 according to the embodiment can be manufactured by forming two kinds of grooves intersecting each other on a cylindrical roller material 400 made of metal or alloy such as copper, aluminum, stainless. More specifically, as shown in FIG. 6A, coil-shaped grooves are formed on the surface of the roller material 400 by a through-feed rolling process of bringing a pair of dies 901 and 902 rotated in the same direction into contact with the surface of the roller material 400 and moving the roller material 400 in a predetermined direction.

A rotation axis A1 of the dies 901 and a center axis A4 of the roller material 400 are not parallel to each other but are slightly inclined (e.g., 1°). In addition, a rotation axis A2 of the dies 902 and the center axis A4 of the roller material 400 are not parallel to each other but are slightly inclined (e.g., −1°). Accordingly, thrust force caused by the rotation of the dies 901 and 902 acts on the roller material 400. When the dies 901 and 902 are rotated, the roller material 400 is transported along the axial direction. In an example shown in FIG. 6A, while the roller material 400 is rotated in a direction D8 indicated by an arrow, the roller material 400 is transported by the rotation of the dies 901 and 902 in a direction D9 indicated by an arrow.

Although not shown specifically, a spiral protrusion is formed on an outer peripheral surface of each of the dies 901 and 902. Such a protrusion comes into contact with the roller material 400, thereby forming two kinds of grooves intersecting in a lattice shape on the outer peripheral surface of the roller material 400. The grooves serve as the concave portion 442 on the surface of the developing roller 44. The plurality of protrusions surrounded with the grooves serve as the convex portions 441 on the surface of the developing roller 44.

A guide 903 extends along a direction D9 of transporting the roller material 400. As shown in FIG. 6B, the dies 901 and 902 are in contact with the roller material 400 at contact positions P1 and P2, and the guide 903 is in contact with the surface of the roller material 400 at a third position P3 on the opposite side with the center axis A4 of the roller material 400, thereby serving as backup means for preventing displacement or distortion of the roller material 400 caused by the press of the dies 901 and 902.

The dies 901 and 902 are in contact with the surface of the roller material 400 so as to roll, but the guide 903 is fixed. For this reason, while the surface of the roller material 400 is rubbed on the guide 903, the roller material 400 is rotated in the direction D8 indicated by the arrow and is transported in the direction D9 indicated by the arrow. At this time, the displacement of the roller material 400 in the circumferential direction is larger than the displacement of the roller material 400 along the axial direction.

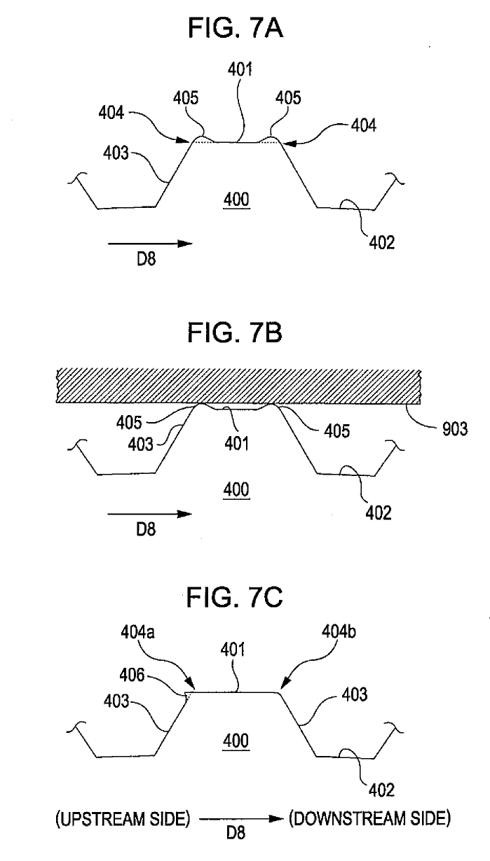

FIG. 7A, FIG. 7B, and FIG. 7C are diagrams illustrating sectional shapes of the unevenness formed by the through-feed rolling process, and more specifically, cross-sectional views illustrating the surface of the roller material 400 pressed by the dies 901 and 902 as viewed from a cutting face perpendicular to the center axis A4. In FIG. 7A, FIG. 7B, and FIG. 7C, the upper and low sides are reversed differently from FIG. 6A and FIG. 6B for convenience of view. As shown in FIG. 7A, on the surface of the roller material 400 pressed by the dies 901 and 902 having a protrusion portion, a groove 402 is carved at a position pressed by the protrusion portion. An original cylindrical surface of a surface 401 that is not in contact with the protrusion portions is kept and becomes the top surface of the convex portion protruding relative to the groove 402. A surface 403 connected between the groove 402 and the top surface 401 of the convex portion becomes a side surface of the convex portion. A rising portion 405 rising from the-original cylindrical surface by the dies is formed around an edge portion 404 at which the side surface 403 and the top surface 401 of the convex portion intersect each other.

As shown in FIG. 7B, the rising portion 405 is forced by press force toward the rear side of the movement direction, that is, toward the substantially upstream side of the rotation direction D8 by rubbing with the guide 903. As a result, the rising portion 405 is thrust toward the upstream side and is plastic-deformed. As shown in FIG. 7C, a protruding portion 406 protruding in a burr shape toward the upstream side is formed at an upstream side edge portion 404a of the top surface 401 of the convex portion 441 corresponding to the rear side of the movement direction D8 according to the rotation, and an angle thereof is gentle at a downstream side edge portion 404b.

In the embodiment, a metal cylinder after the process of forming the unevenness on the roller material 400 is rotatably disposed in the housing 41 (see FIG. 4) by a shaft and the metal cylinder serves as the developing roller 44. That is, the grooves 402 formed on the surface of the roller material 400 corresponds to the concave portions 442 in the developing roller 44, and the original cylindrical surface 401 corresponds to the convex portions 441.

Considering that the shapes of the edge portions of the convex portion 441 are different from each other on the upstream side and the downstream side of the rotation direction D8 at the processing time, in the embodiment, the developer 4K is provided with the developing roller 44 so that the rotation direction D4 (see FIG. 4) at the time of the image forming operation of the developing roller 44 mounted on the developer 4K or the like is the same direction as the rotation direction D8 at the time of the through-feed rolling process. The reason will be described hereinafter.

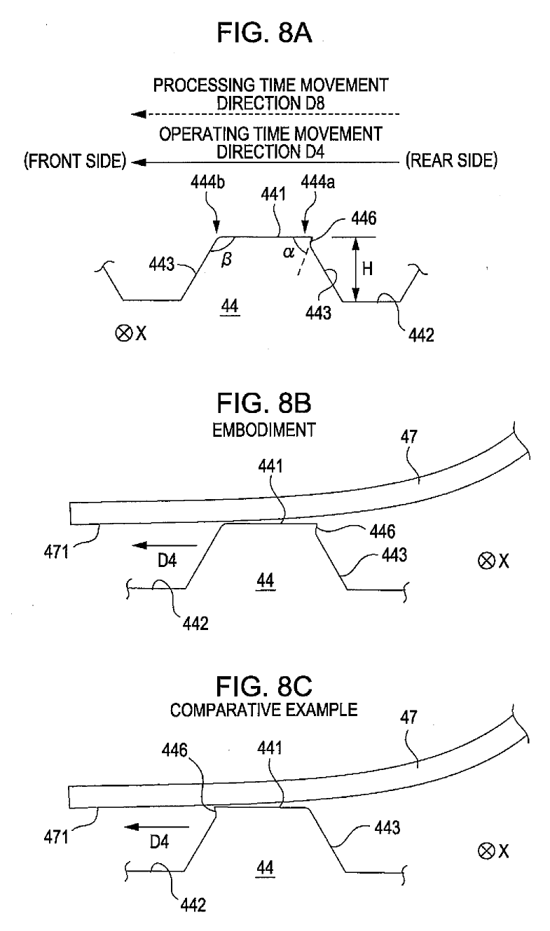

FIG. 8A, FIG. 8B, and FIG. 8C are enlarged diagrams illustrating the shapes of the edge portions of the developing rollers. As shown in FIG. BA, by providing the developing roller 44 on the housing 41, the front side of the rotation direction D8 at the processing time, that is, an edge portion 444b with a gentle angle becomes the front side of the movement direction D4 according to the rotation of the developing roller 44 on the top surface of the convex portion 441 formed on the surface of the developing roller 44. The edge portion 444a having a burr-shaped protruding portion 446 formed thereon is positioned on the rear side of the movement direction D4 at the time of the image forming operation. In the front edge portion 444a and the rear edge portion 444b, angles formed by the top surface of the convex portion 441 and the side surface 443 connected thereto are represented by β and α. A difference in height between the convex portion 441 and the concave portion 442 is represented by H.

In the through-feed rolling process method, the dies is put onto the outer peripheral surface of the metal cylinder and carves the outer peripheral surface, thereby forming the concave portion 442. Accordingly, the angle β in the front edge portion 444b is larger than 90°. The angle α at the rear end edge portion 444a, at which the protruding portion 446 is formed, is smaller than the angle β and is sharp.

When the seal member 47 comes into contact with the surface of the developing roller 44 and the developing roller 44 is rotated in the rotation direction D4, the convex portion 441 approaches and comes into contact with the surface 471 of the seal member 47 with the gentle edge portion 444b opposite to the protruding portion 446 as the head, as shown in FIG. 8B. For this reason, the contact with the surface 471 of the seal member 47 is smooth, and abrasion by rubbing with the convex portion 441 is little.

As shown in FIG. 8C, in a comparative example in which the dispositional direction of the developing roller 44 is reverse and the rotation direction D8 at the processing time is opposite to the rotation direction D4 at the operating time, the sharper edge portion 444a comes into contact with the surface 471 of the seal member 47 with the edge portion 444a as the head. For this reason, the surface 471 of the seal member 47 is easily cut, the seal effect is decreased by the abrasion of the seal member 47, or the durability of the apparatus is shortened. In the embodiment, the developing roller 44 is disposed in the developer 4K or the like in a direction of reducing such abrasion, thereby extending the durability of the apparatus.

A material of the seal member 47 will be examined. It is preferable that at least a part coming into contact with the surface of the developing roller 44 of the center of the seal member 47 is formed of a material to which toner, additives, or the like are hardly attached. The present inventors carried out a test for certifying aptitude as the seal member, in consideration of a contract angle with respect to water among properties of matter. The result will be described hereinafter.

The test was carried out as follows. First, as a resin material having appropriate flexibility and lubricity and usable as the seal member 47, polytetrafluoroethylene (PTFE), ethylene-tetrafluoroethylene copolymer (ETFE), tetrafluoroethylene-perfluoroalkoxyehthylene copolymer (PFA), polymer polyethylene (PE), polycarbonate (PC), polyvinylidene fluoride (PVDF), poly amide (PA) were selected and contact angles with respect to water were measured. The measuring was performed by a contact angle system DM700 manufactured by Kyowa Interface Science, Co., Ltd. Distilled water of 1 micro litter was dropped down onto the surfaces of the materials, and an average value of the measurement values at five points from the time after 1 second to the time after 4.8 seconds.

The seal member manufactured by processing each of the materials in a predetermined shape was mounted on the developer to perform the image forming operation, thereby forming total 2000 sheets of images in an off-and-on manner. Then, a filming test was carried out to confirm whether or not filming occurs in the developing roller 44. The result will be represented as follows.

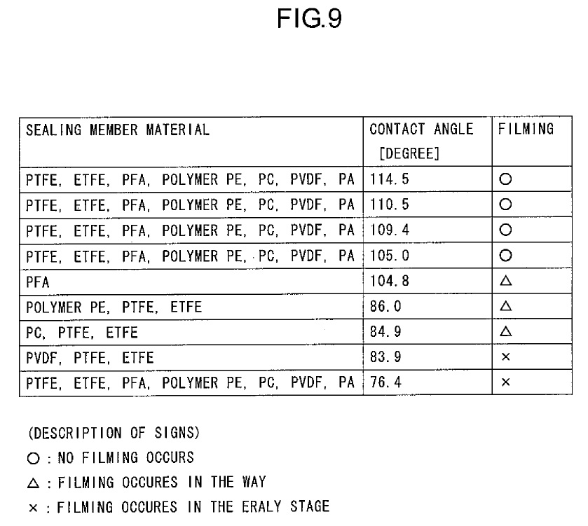

FIG. 9 is a diagram illustrating the filming test result about the seal members made of various kinds of materials. As shown in FIG. 9, a clear correlation is represented between the size of the contact angle and the state of occurrence of filming. When the contact angle is large, filming hardly occurs. That is, in the seal member made of all having a contact angle of 105° or more, no filming was represented in the developing roller 44 even after forming 2000 sheets of images. In the seal member made of all having a contact angle smaller than 76.4°, filming occurred in the early stage after starting the operation. In PFA, polymer PE, PC, PTFE, ETFE, and the like in such an angle range (85 to 105°), no filming occurred in the early stage, but filming occurred at the time point of forming about 10000 sheets of images, and thus it was found that they are not sufficient as the seal member.

According to the test, it was disclosed that PTFE and ETFE cause the satisfactory result, but PVDF and PFA are not suitable for the seal member in spite of the same fluorine group. In polymer PE considered useful as high abrasion resistance, a preferable result about filming cannot be necessarily obtained. As described above, there is a meaning in that the aptitude as the seal member is assessed by the contact angle of the material, but it was found that it is difficult to perform determination from a composition of a resin material or the other property of matter.

As the seal member, the material having the contact angle of 105° or more with respect to water is preferable, specifically, for example, PTFE resin and ETFE resin can be appropriately used. The material having the large contact angle with respect to water has a high deformation property, and is hardly attached to the other material. Accordingly, they are suitable for the seal member for avoiding the attachment of toner or the like.

The materials such as PTFE resin and ETFE resin are smooth and are easily worn out as compared with, for example, PE resin or the like. For this reason, it is worried that the abrasion of the seal member reduces the durability of the apparatus. However, as described above, in the embodiment, the developer 4K or the like is configured (see FIG. 8B) so that the burr-shaped protruding portion 446 formed on the surface in the course of manufacturing the developing roller 44 is the rear side of the rotation direction D4. Accordingly, the abrasion of the seal member is suppressed, and a material which does not have such high abrasion resistance can be employed as the seal member. For example, in a general developer using a developing roller, a surface of which is blast-processed, or an apparatus using a method of disposing the developing roller reverse to that of the embodiment, the surface has an irregular and sharp shape easy to cut the seal member. Accordingly, a soft material that does not have high abrasion resistance is not suitable for the seal member.

In the soft materials such as PTFE resin and ETFE resin, a part thereof is cut by the convex portion 441 and the cut part is transferred to the top surface, thereby having an effect to suppress toner from being attached to the convex portion 441, which was experimentally confirmed by the present inventors. That is, the top surface of the convex portion 441 is coated with the materials having the large contact angle such as PTFE resin and ETFE resin, thereby suppressing toner particles or additives from being attached to the top surface of the convex portion 441. This effect is preferable in the viewpoint of stabilization of the amount of transported toner on the developing roller 44, suppressing of scattering of toner from the developer, and suppressing of filming.

In the developer using the developing roller, the surface of which is blast-processed, it is necessary to pay attention on the charging of the toner caused by the contact between the toner carried on the surface of the developing roller and the seal member. The reason is because the toner is easily attached to the seal member or is easily scattered to the outside of the developer, according to whether the contact with the seal member charges the toner into any polarity. In the known developer, a material of the seal member needs to be determined by considering a positional relation with the toner in triboelectric series as well as solidity or abrasion resistance.

In the developer 4K or the like according the embodiment, the toner is basically carried in the concave portions 442 and is not carried on the convex portions 441. Accordingly, the charging of the toner caused by the contact with the seal member 47 does not substantially cause a problem. For this reason, it is possible to select a proper material without depending on the positional relation with the toner in the triboelectric series.

To prevent the toner carried in the concave portions 442 from contact with the seal member 47, a difference in height (Reference Numeral H shown in FIG. 8A) between the concave portions 442 and the convex portions 441 of the surface of the developing roller 44 is also important. It is preferable that the difference H in height is larger than a volume average diameter of the used toner. The reason is because the charging of the toner or the attaching of the additives to the seal member 47 easily occur since toner more protruding than the convex portions 441 of the toner carried in the concave portion 442 easily comes into contact with the seal member 47 when the difference H in height is equal to or smaller than the volume average diameter of the toner. Toner having a large diameter pushes up the seal member 47, and thus the seal effect may be attenuated. In the test carried out by the present inventors, when the difference H in height was 1.5 times the volume average diameter of the toner, such a problem hardly occurred.

As described above, in the embodiment, the regular unevenness is formed on the surface of the roller material 400 by the through-teed rolling process for pressing the dies 901 and 902 and the guide 903 to the cylindrical metal roller material 400, and the roller material 400 is provided in the developer 4K or the like, as the developing roller 44. The rotation direction D4 of the developing roller 44 provided in the developer 4K or the like and used for the image forming operation is the same as the rotation direction D8 of the roller material 400 at the time of through-feed rolling process. For this reason, the angle formed by the top surfaces of the convex portions and the side surfaces connected thereto on the front side (angle β) of the movement direction D4 of the developing roller 44 is larger than that on the rear side (angle α) thereof. With such a configuration, the abrasion of the seal member 47 is suppressed, thereby extending the durability of the apparatus.

The material of the seal member 47 is selected using the contact angle with respect to water as an indicator, and the materials having the contact angle of 105° or more, specifically, PTFE resin or ETFE resin are used. Such materials have a high deformation property, and thus the materials are not easily attached to the other materials. Accordingly, it is possible to appropriately use the materials as the seal member to which toner or additives need not to be attached. That is, since the seal member is formed of such materials, it is possible to prevent the toner from leaking out of the developer caused by the fixing of the toner or the like to the seal member 47, or to prevent filming on the developing roller 44, the feeding roller 43, and the restriction blade 46.

In the embodiment, the developing roller 44 capable of suppressing the abrasion of the seal member as described above is combined with the seal member 47 formed of the material having the high deformation property having the effect of suppressing the attachment of the toner or additives. Accordingly, it is possible to cope with the problem in durability of the apparatus caused by the abrasion of the seal member while suppressing the leakage of toner or the filming caused by the attachment of the toner or additives.

As described above, in the embodiment, the developers 4C, 4K, 4M, and 4Y serve as the developing device according to the invention, and the housing 41, the developing roller 44, and the seal member 47 serve as the housing, the toner carrying roller, and the seal member according to the invention, respectively. The photoreceptor 2 serves as the image carrier according to the invention. The process of forming the unevenness on the surface of the roller material 400 by the through-feed rolling process shown in FIG. 6A and FIG. 6B corresponds to the process of forming the regular unevenness, thereby manufacturing the toner carrying roller according to the invention. The process of disposing the developing roller 44 and the seal member 47 in the housing 41 corresponds to the process of providing the housing with the seal member according to the invention.

The invention is not limited to the embodiment, and may be variously modified within the technical scope of the invention. For example, the convex portions 441 of the developing roller 44 according to the embodiment are formed substantially in a tomb shape, the shape of the convex portions is not limited thereto. For example, the shape may be a round shape, a triangular shape, or the other shape.

In the embodiment, PTFE resin or ETFE resin is used as the material of the seal member 47, but the whole of the seal member 47 is not necessarily formed of such a material. For example, a member obtained by coating a surface in contact with the developing roller 44 in a base material formed of the other material, with PTFE resin or ETFE resin may be used as the seal member 47.

The image forming apparatus according to the embodiment is a color image forming apparatus in which the rotary developing unit 4 is provided with the developer 4K and the like, but is not limited thereto. For example, the invention is applicable to a tandem color image forming apparatus in which a plurality of developers are arranged along an intermediate transfer belt, or a monochromatic image forming apparatus with one developer forming a monochromatic image.

What is claimed is:

1. A developing device comprising:
a housing that stores toner therein;
a toner carrying roller that is attached to the housing by a shaft and is rotated in a predetermined rotation direction while carrying charged toner on a surface of the toner carrying roller to transport the toner to the outside of the housing; and
a seal member that extends in a direction of a rotation axis of the toner carrying roller and has one end fixed to the housing and the other end in contact with the surface of the toner carrying roller to prevent the toner from leaking out of the housing,
wherein a plurality of convex portions having top surfaces constituting a part of the same cylindrical surface are formed on the surface of the toner carrying roller, and at least a part of the seal member in contact with the surface of the toner carrying roller is made of a material having a contact angle of 105° or more with respect to water.

2. A developing device comprising:
a housing that stores toner therein;
a toner carrying roller that is attached to the housing by a shaft and is rotated in a predetermined rotation direction while carrying charged toner on a surface of the toner carrying roller to transport the toner to the outside of the housing; and
a seal member that extends in a direction of a rotation axis of the toner carrying roller and has one end fixed to the housing and the other end in contact with the surface of the toner carrying roller to prevent the toner from leaking out of the housing,
wherein a plurality of convex portions having top surfaces constituting a part of the same cylindrical surface are formed on the surface of the toner carrying roller, and at least a part of the seal member in contact with the surface of the toner carrying roller is made of polytetrafluoroethylene resin or ethylene-tetrafluoroethylene copolymer resin.

3. The developing device according to claim 1 or 2, wherein the convex portions formed on the surface of the toner carrying roller are formed by a through-feed rolling process, and the predetermined rotation direction is the same direction as the rotation direction of the toner carrying roller at the time of the through-feed rolling process.

4. The developing device according to claim 1 or 2, wherein on the surface of the toner carrying roller, a difference in height between the convex portions and the concave portions surrounding the convex portions is larger than a volume average diameter of the toner.

5. An image forming apparatus comprising:
a housing that stores toner therein;
a toner carrying roller that is attached to the housing by a shaft and is rotated in a predetermined rotation direction while carrying charged toner on a surface of the toner carrying roller to transport the toner to the outside of the housing;
a seal member that extends in a direction of a rotation axis of the toner carrying roller and has one end fixed to the housing and the other end in contact with the surface of the toner carrying roller to prevent the toner from leaking out of the housing; and
an image carrier that is disposed opposite to the toner carrying roller and carries an electrostatic latent image on a surface thereof,
wherein a plurality of convex portions having top surfaces constituting a part of the same cylindrical surface are formed on the surface of the toner carrying roller, and at least a part of the seal member in contact with the surface of the toner carrying roller is made of a material having a contact angle of 105° or more with respect to water.

6. A method of manufacturing a developing device comprising:
forming regular unevenness on a surface of a substantially cylindrical roller material by a throughfeed rolling process, thereby manufacturing a toner carrying roller; and
providing a housing for storing toner therein with a seal member made of a material having a contact angle of 105° or more with respect to water, and attaching the toner carrying roller to be rotatable in a predetermined rotation direction by a shaft,
wherein the predetermined rotation direction is the same direction as the rotation direction of the roller material at the time of the through-feed rolling process.

7. The method of manufacturing a developing device according to claim 6, wherein in the forming of the regular unevenness, the roller material is rotated in the same direction as the predetermined rotation direction in a state where dies and a backup unit are in contact with a surface of the roller material at positions different from one another.
